(19) United States
(12) Patent Application Publication
(10) Pub. No.: US 2025/0177887 A1
(43) Pub. Date: Jun. 5, 2025

(54) LADDER-LIKE GRATING, AND METHOD FOR PRODUCING A LADDER-LIKE GRATING

(71) Applicant: ACO AHLMANN SE & CO. KG, BUDELSDORF (DE)

(72) Inventor: Jirí Sedmík, Havlíckuv Brod (CZ)

(21) Appl. No.: 18/843,778

(22) PCT Filed: Mar. 29, 2023
(86) PCT No.: PCT/EP2023/058143

§ 371 Date: Sep. 4, 2024

(30) Foreign Application Priority Data
Mar. 31, 2022 (DE) 10 2022 107 670.9

(51) Int. Cl. B01D 29/05; B01D 29/01; B21D 28/26; E01C 9/10

(52) U.S. Cl. CPC B01D 29/05; B01D 29/012; B21D 28/26; E01C 9/10

(57) ABSTRACT

The present invention relates to a ladder-like grating (10) comprising a plurality of longitudinally extending support sections (12) and a plurality of transversely extending sections (14). The transversely extending sections extend between the longitudinally extending support sections, wherein each transversely extending section comprises one flat subsection (18) and two connecting subsections (20), one at each end of the flat subsection. Each connecting subsection is a twisted rectangular strip extending transversely from one of the longitudinally extending support sections to the flat subsection of the transversely extending section. The present invention also relates to a method for producing a ladder-like grating.

### PRIOR ART

Drainage channels are commonly used to ensure adequate drainage of surface liquid in a large number of different environments, for example, in industrial facilities, transport infrastructure, and in the drainage of businesses and homes. These drainage channels are used to direct surface liquid along the channel to one or more individual drainage points, by which drainage is ensured along an extended section of a surface without the need for a large number of drainage points.

Drainage channels comprise a channel, usually manufactured from metal, such as stainless steel, and shaped to direct the wastewater to one or more drainage points. Each drainage channel generally also comprises a grating installed on top of the channel to prevent large, solid objects from entering and to be able to support various loads such as vehicles, pedestrians, and large objects.

A common design of these gratings are ladder-like gratings, in which multiple flat bars form rungs that are arranged between two further flat support bars. Ladder-like gratings are generally produced by welding the rungs to the two support bars so that the rungs extend perpendicularly from the support bars.

However, welded ladder-like gratings have a number of significant disadvantages. Welded connections tend to be more brittle, so the fatigue strength of this connection is lower than other connecting methods. The welds form corners between the support bars and the rungs that are difficult to clean, making it difficult to ensure a high hygiene standard; hygiene standards are of particular importance when the ladder-like gratings are used in a food production facility or kitchen.

It is therefore desirable to develop a ladder-like grating that has a stronger connection between the rung and the support bar and a structure that is easier to clean.

In addition, the production method of welded ladder-like gratings also has a number of disadvantages. Each individual rung has to be welded individually to the two support rods, which results in a very lengthy production method that reduces the efficiency of production and increases production costs. If changes to the grating are necessary, additional processing steps are required, which further reduces the efficiency of the process.

In addition, the welding process involves material costs, which further increase the costs of producing a welded ladder-like grating. It is therefore desirable to develop a method for producing a ladder-like grating that improves production efficiency and reduces costs.

### SUMMARY OF THE INVENTION

The present invention relates to a ladder-like grating comprising a plurality of longitudinally extending support sections and a plurality of transversely extending sections. The transversely extending sections extend between the longitudinally extending support sections, wherein each transversely extending section comprises one flat subsection and two connecting subsections, one at each end of the flat subsection. Each connecting subsection is a twisted rectangular strip extending in the transverse direction from one of the longitudinally extending support sections to the flat subsection of the transversely extending section.

The present invention also relates to a method for producing a ladder-like grating comprising a material removal step, in which sections of a solid sheet of material extending across a flat plane are removed to form a plurality of elongated holes extending transversely between longitudinally extending support sections of the solid sheet and transversely extending sections of the solid sheet extending between the longitudinally extending support sections; a first bending step, in which the longitudinally extending support sections are bent such that they extend substantially perpendicularly from the transversely extending sections; a second bending step, in which the transversely extending sections are bent such that a part of each of the transversely extending sections is rotated around the axis in which they extend transversely until it is substantially perpendicular to the flat plane over which the solid sheet originally extends.

### Technical Advantages

The present invention provides a ladder-like grating which is formed from a single piece and therefore has improved strength in the area of the connection between the rungs and the support sections. The present invention can also be more easily cleaned in this connection area, by which a more hygienic product is provided that can more easily meet the required hygiene standards.

Furthermore, the present invention provides an efficient production method that requires fewer steps than known methods and is not dependent on the number of rungs. The production method of the present invention therefore has lower material and production costs than known methods. The production method of the present invention also enables simple modifications, such as adding anti-slip features to the ladder-like grating during production.

### BRIEF DESCRIPTION OF THE FIGURES

FIG. 1 relates to a top view of a ladder-like grating according to a first embodiment of the present invention.

FIG. 2 relates to a bottom view of a ladder-like grating according to a first embodiment of the present invention.

FIG. 3a relates to a a first frontal view of a ladder-like grating according to a first embodiment of the present invention.

FIG. 3b relates to a second frontal view of a ladder-like grating according to a first embodiment of the present invention.

FIG. 4 relates to a perspective top view of a ladder-like grating according to a first embodiment of the present invention.

FIG. 5 relates to a perspective rear view of a ladder-like grating according to a first embodiment of the present invention.

FIG. 6 relates to a top view of a ladder-like grating according to a second embodiment of the present invention.

FIG. 7 relates to a bottom view of a ladder-like grating according to a second embodiment of the present invention.

FIG. 8a relates to a first frontal view of a ladder-like grating according to a second embodiment of the present invention.

FIG. 8b relates to a second frontal view of a ladder-like grating according to a second embodiment of the present invention.

FIG. 9 relates to a perspective top view of a ladder-like grating according to a second embodiment of the present invention.

FIG. 10 relates to a perspective rear view of a part of a ladder-like grating according to a second embodiment of the present invention.

FIG. 11 relates to an illustration of steps of a method for producing a ladder-like grating according to an embodiment of the present invention.

### DETAILED DESCRIPTION OF THE FIGURES

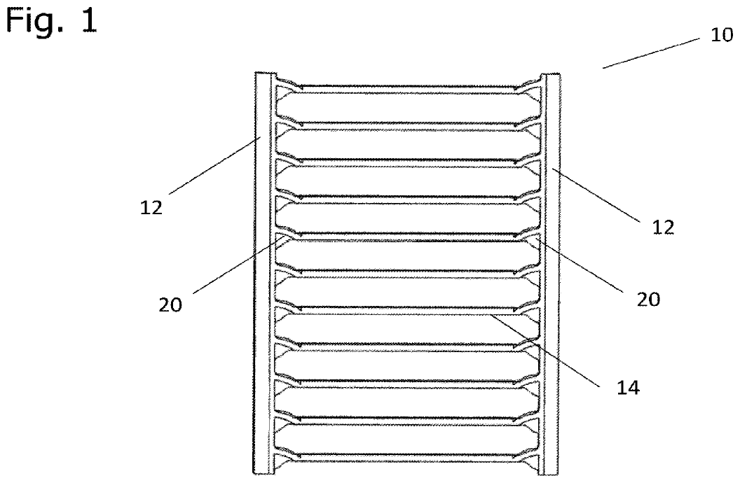

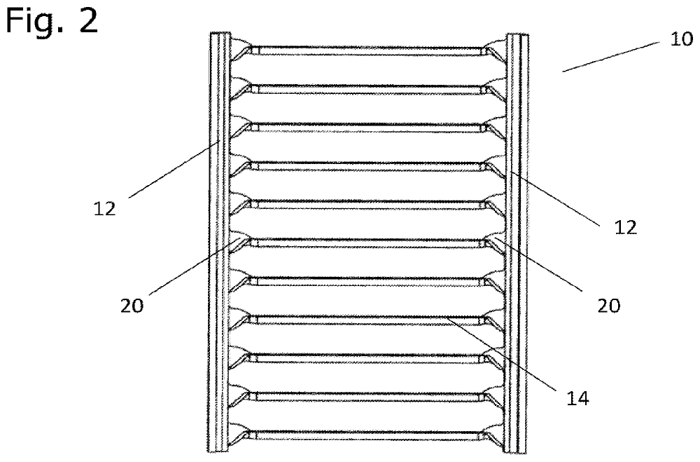

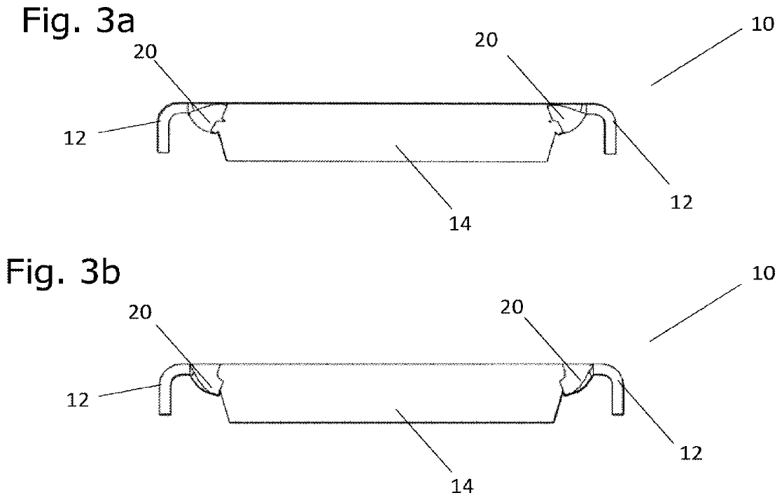

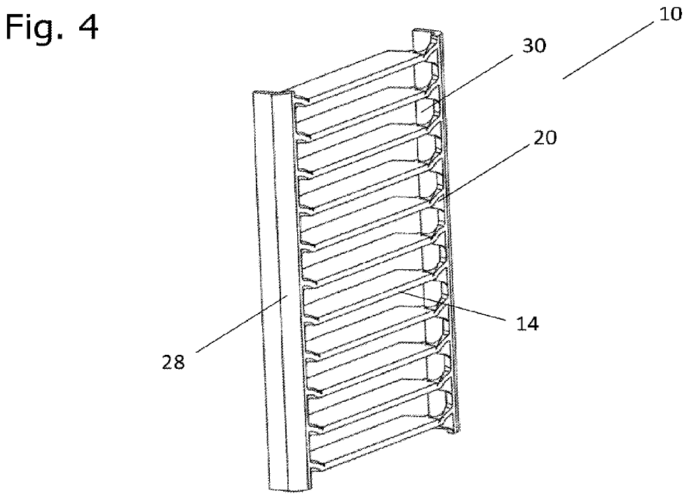

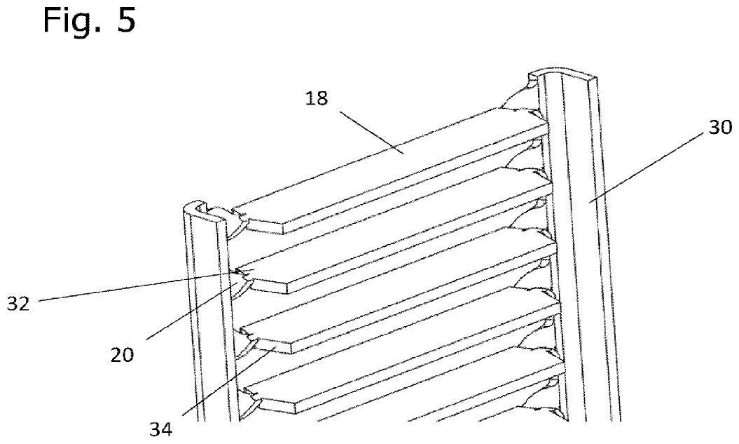

A first aspect of the present invention relates to a ladder-like grating for a drainage channel. A ladder-like grating according to a first embodiment of the present invention is shown in FIGS. 1-5 and is described below.

The ladder-like grating 10 shown in FIGS. 1-5 is formed from a single piece 16. The single piece 16 is preferably a piece of sheet metal that has been machined and deformed to produce the ladder-like grating 10 as seen in the first embodiment. The ladder-like grating 10 of FIG. 1 is preferably produced by means of a ladder-like grating production method according to the claimed invention, an example of which is also described in the present description.

The ladder-like grating 10 of FIGS. 1-5 comprises a number of sections and elements as described herein. It is clear that these sections and elements form a continuous piece and are not connected by additional features or materials. The ladder-like grating 10 preferably comprises rounded edges and corners for each of the components that are arranged perpendicular or substantially perpendicular to the components to which they are connected.

The ladder-like grating 10 comprises a plurality of longitudinally extending support sections 12. The longitudinally extending support sections 12 extend in a longitudinal direction, i.e. in a direction along which the fluid flows in the drainage channel over which the ladder-like grating 10 is to be positioned. The ladder-like grating 10 preferably comprises two longitudinally extending support sections 12, wherein each longitudinally extending support section 12 is arranged on a respective side of the drainage channel.

The ladder-like grating 10 of the first embodiment shown in FIGS. 1 to 5 also comprises a plurality of transversely extending sections 14. Each of the transversely extending sections 14 extends between the two longitudinally extending support sections 12, wherein they are preferably arranged equidistantly from one another, but may also be arranged non-equidistantly depending on the environment in which the ladder-like grating 10 is to be used. The transversely extending sections 14 comprise flat subsections 18, which are preferably flat strips or bars extending parallel to one another, wherein the flat surfaces of the flat strips are preferably opposite to one another.

In the ladder-like grating 10 according to the first embodiment of FIGS. 1-5, each of the transversely extending sections 14 comprises a connecting subsection 20 at each end of the flat subsection 18. This connecting subsection 20 is preferably narrower than the flat subsection 18 and therefore only adjoins a part 32 of the end of the flat subsection 18.

The connecting subsection 20 is a twisted rectangular strip extending in the transverse direction from one of the longitudinally extending support sections to the flat subsection 18 of the transversely extending section. The connecting subsection 20 has a helical shape, wherein one end of the connecting subsection 20 is rotated by approximately 90 degrees, preferably exactly 90 degrees, relative to the other end of the connecting subsection 20. In other words, the helical shape is twisted by 90 degrees around a transversely extending axis. Preferably, the rectangular strip is narrower than the flat subsection 18 of the transversely extending section 14 which it adjoins.

The connecting subsection 20 is twisted to connect the end of the flat subsection 18 of the transversely extending section 14 to the side of the longitudinally extending support section 12, which are arranged in perpendicular flat planes.

This twisted connection allows the ladder-like grating 10 to be formed from a single material piece 14, wherein welding or other connecting technologies are not necessary to connect the transversely extending section 14 and the longitudinally extending support section 12.

These transverse sections 14 can be viewed as “rungs” or “steps” of the ladder-like grating 10 and help during use guiding liquids from the top of the ladder-like grating 10 to the bottom of the ladder-like grating 10, while also being able to carry a load when objects, vehicles, or persons are on top of the ladder-like grating 10. The transversely extending sections 14 are preferably spaced apart such that liquids can flow in the gaps between them. They are also preferably spaced apart so as to prevent objects of a certain size and larger from passing through the grating.

Since ladder-like gratings are typically used in environments where people move around on foot, the ladder-like grating 10 can be provided with anti-slip features to provide a better hold between the ladder-like grating 10 and the bottom of a shoe or wheel. In a preferred embodiment of the present invention, which is not shown in the figures, the ladder-like grating 10 can be provided with anti-slip features. These anti-slip features can be designed in the form of indentations or projections along the upper edge of the transversely extending sections 14. The depressions or projections can be arranged equidistantly along the transversely extending sections 14 and preferably have a semicircular shape, although other shapes can be used.

Preferably, the longitudinally extending support sections 12 are arranged parallel to one another, but can be positioned in a different arrangement depending on the shape of the drainage channel with which the ladder-like grating 10 is used.

Each longitudinally extending support section 12 comprises a flat element 30 which is a flat strip or bar extending both perpendicular to the transverse direction in which the transversely extending sections extend and perpendicular to the longitudinal direction. In addition, each longitudinally extending support section 12 comprises a curved element 28 that connects the flat element 30 to the transversely extending connecting subsection 20 of the transversely extending section 14. The curved element 28 forms a curved corner extending along a longitudinal edge of the flat element 30.

### Second Embodiment

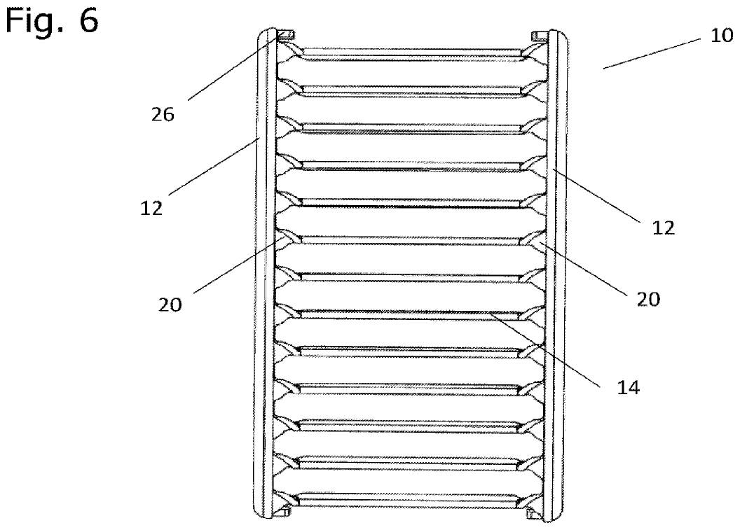

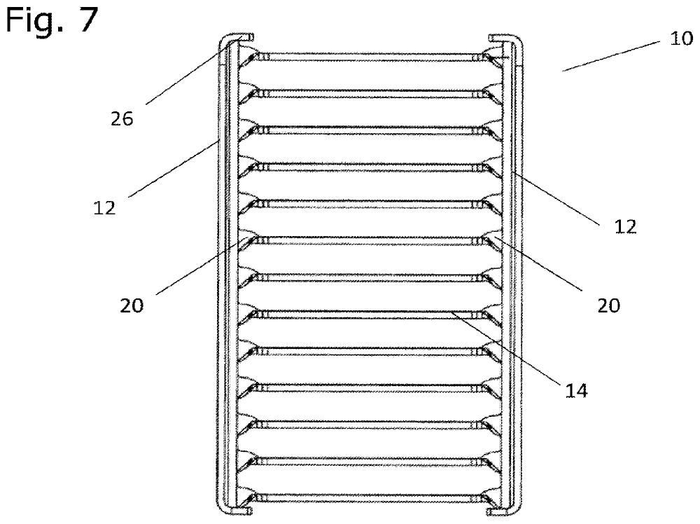

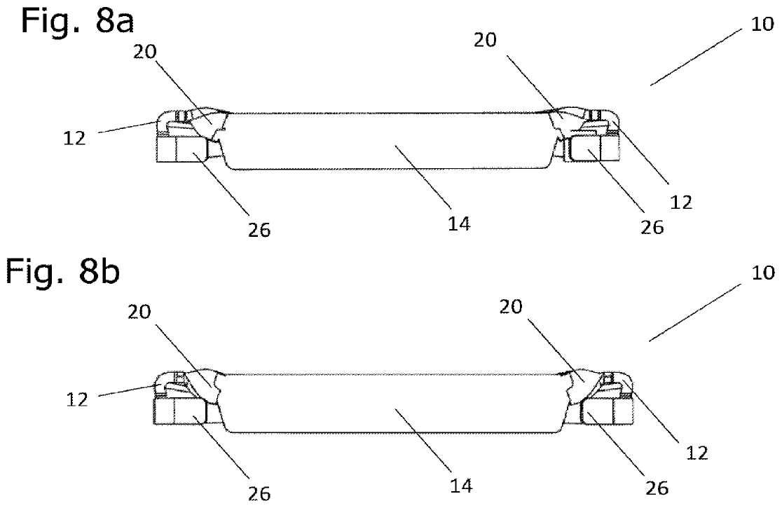

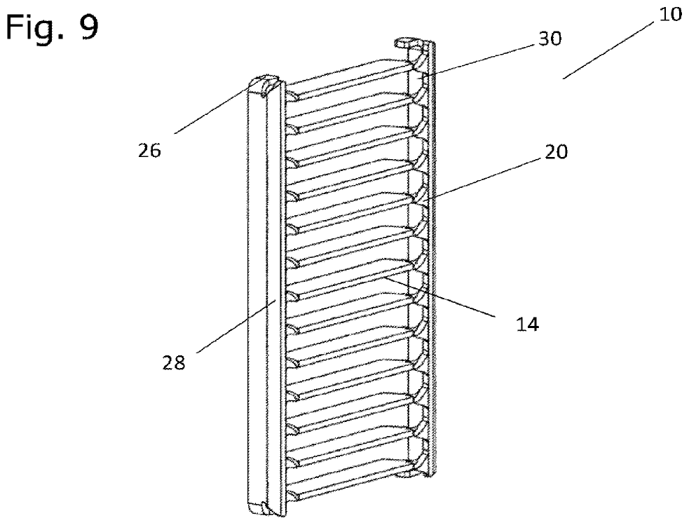

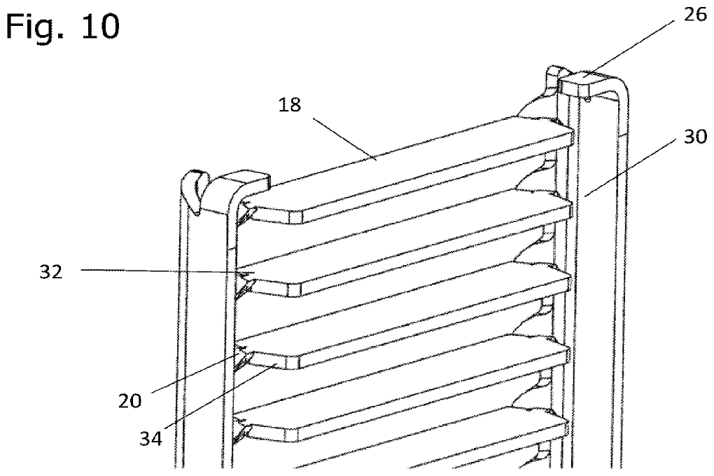

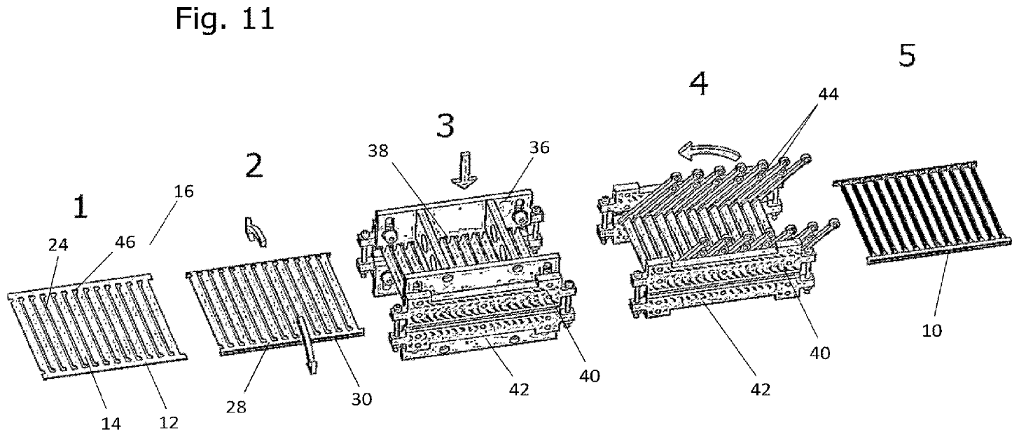

A second embodiment can also be seen in FIGS. 6-10. The second embodiment comprises the same features as the first embodiment unless otherwise stated herein. Identical features of the first and second embodiments are represented in the figures by identical reference numerals.

The second embodiment differs from the first embodiment due to the presence of end tabs 26. The ladder-like grating according to the second embodiment also comprises end tabs 26 at each end of each longitudinally extending support section 12, wherein the end tabs 26 extend transversely and form a suitable barrier which enables installation in a drainage channel.

### Method

A second aspect of the present invention also relates to a method for producing a ladder-like grating for a drainage channel, preferably a ladder-like grating according to the first aspect of the present invention. An embodiment of the method according to the invention is shown in FIG. 6 and is described here.

The process first begins with a workpiece, which is a solid material sheet extending over a flat surface. The solid material sheet is preferably metal. The solid material sheet is preferably steel, particularly preferably stainless steel or galvanized steel. Step 1, as shown in FIG. 6, is a material removal step in which sections of the solid material sheet are removed to form a plurality of elongated holes 24. These holes extend transversely across the width of the solid sheet. Due to the resulting holes, material strips remain in the solid sheet between the ends of the elongated holes 24 and the edge of the solid sheet. These material strips are viewed as longitudinally extending support sections 12 of the solid sheet.

The holes also leave behind material strips which extend transversely across the width of the solid sheet and are viewed as transversely extending sections 14. The transversely extending sections 14 are thus located between the individual holes and extend between the longitudinally extending support sections 12.

The material removal step can be any process that removes material from the solid sheet to form the elongated holes 24. This process is preferably a laser cutting process.

In a preferred embodiment of the invention, the material removal step also comprises forming the elongated holes 24 with anti-slip features. The anti-slip features are preferably depressions arranged along at least one of the transversely extending edges of each of the elongated holes 24. Alternatively, the material removal step can remove material such that projections remain on the transversely extending edges which form the anti-slip features.

It is also preferred that the elongated holes 24 have a part 46 at each end of the elongated holes 24 which is larger in the longitudinal direction. This larger part of the elongated holes 24 ensures that the transversely extending sections are narrower at the ends, due to which these narrower sections are more easily twistable. The narrower part of the flat subsection 18 can be viewed as a transversely extending, connected section 32, while the unconnected portion of the flat subsection 18 can be viewed as a transversely extending, unconnected section 34.

Step 2, as shown in FIG. 6, is a first bending step. In the first bending step, the longitudinally extending support sections 12 are bent such that they run perpendicular to the transversely extending sections 14. The longitudinally extending support sections 12 are bent around a longitudinally extending axis to thereby form a bent element 28 and a corresponding material strip that forms a flat element 30, wherein both elements extend longitudinally.

Preferably, the longitudinally extending support sections 12 are bent simultaneously. This reduces the time required for the first bending step and thus improves the efficiency of the method.

In the preferred embodiment of the present invention shown in FIG. 6, the method comprises a step 3 which is a pressing step. In the pressing step, the workpiece is arranged between an upper clamping section 40 and a lower clamping section 42. A pressing machine 36 having two rows of a plurality of triangular teeth 38 arranged along the longitudinal direction presses on the transversely extending sections 14. The pressing machine 36 preferably has the same number of teeth 38 as the number of transversely extending sections and they are arranged at corresponding positions.

The teeth 38 press on the flat subsection 18 of the transversely extending section 14. The area of the flat subsection 18 which is pressed by the teeth 38 is preferably the rear side of the flat subsection 18 in the longitudinal direction of the workpiece.

The rows of teeth 38 are preferably not arranged at the end of each transversely extending section 14. When the teeth 38 are pressed, they rotate the transversely extending sections 14 around a transversely extending axis that passes through the transversely extending section 14.

This pressing action deforms the transversely extending section 14 and causes the part of the transversely extending section 14 between the teeth 38 and the longitudinally extending support sections 12 to be twisted. The twisted section thus forms a connection between a flat subsection 18 of the transversely extending section 14 and the longitudinally extending support section 12 and is thus viewed as a connecting subsection 20.

The method of the preferred embodiment shown in FIG. 6 furthermore comprises a second bending step. In the second bending step, shown as step 4 in FIG. 6, the transversely extending sections 14 are bent such that they extend perpendicular to the flat plane over which the solid material sheet originally extends. The workpiece is preferably still held between the upper clamping section 40 and the lower clamping section 42.

The rotation of the transversely extending sections 14 in the second bending step is effectuated by each transversely extending section 14 being contacted on opposite sides by a clamping device 44. The clamping device 44 preferably comprises two rows of two-pronged forks. The two prongs are preferably arranged corresponding to the transversely extending sections 14. Preferably, they are arranged at approximately the same point as the teeth 38 of the pressing step.

One prong of the two prongs is attached to one side of the transversely extending section 14 and the other prong is attached to the opposite side to ensure a clamping function. Once clamped, the clamping device 44 is rotated around the transversely extending section 14 so that the transversely extending part is brought into a position of approximately 90 degrees, preferably 90 degrees, relative to the original plane in which the solid material sheet originally extends.

Preferably, the transversely extending sections 14 are rotated simultaneously, each using a corresponding two-pronged fork. In this way, the preparation of the transversely extending sections 14 can be carried out more efficiently since individual fastening steps are not required for each transversely extending section 14.

Optionally, the material removal step can ensure that the longitudinally extending sections have an additional longitudinally extending piece at each end of each longitudinally extending section, wherein the method optionally comprises a final bending step in which the extending pieces of each longitudinally extending section are bent inward so as to extend transversely in the form of end tabs 26.

### REFERENCE SIGNS

10 ladder-like grating
12 longitudinally extending support section
14 transversely extending section
16 single material piece/solid material sheet
18 flat subsection of transversely extending section
20 connecting subsection of transversely extending section
24 elongated holes
26 end tab of longitudinally extending support section
28 bent element of longitudinally extending support section
30 flat element of longitudinally extending support section
32 transversely extending connected subsection
34 transversely extending unconnected subsection
36 pressing machine
38 teeth of the pressing machine
40 upper clamping section
42 lower clamping section
44 clamping device
46 wider part of the elongated hole

1. A ladder-like grating comprising:
a plurality of longitudinally extending support sections;
a plurality of transversely extending sections;
wherein the transversely extending sections extend between the longitudinally extending support sections;
wherein each transversely extending section comprises a flat subsection and two connecting subsections, one at each end of the flat subsection;
where each connecting subsection is a twisted rectangular strip extending in the transverse direction from one of the longitudinally extending support sections to the flat subsection of the transversely extending section.

2. The ladder-like grating according to claim 1, wherein the longitudinally extending support sections and the transversely extending sections are formed from a single material piece.

3. The ladder-like grating according to claim 2, wherein the single material piece is a piece of sheet metal.

4. The ladder-like grating according to claim 1, wherein the connecting subsection has a helical shape twisted by approximately 90 degrees around a transversely extending axis.

5. The ladder-like grating according to claim 1, wherein the rectangular strip is narrower than the flat part of the transversely extending section to which it is connected.

6. The ladder-like grating according to claim 1, wherein the grating has anti-slip features.

7. The ladder-like grating according to claim 6, wherein the anti-slip features comprise a plurality of depressions or projections along the transversely extending edges of the transversely extending sections.

8. The ladder-like grating according to claim 1, wherein each connecting subsection is connected to a part of the end of the flat subsection.

9. A method for producing a ladder-like grating comprising:
a material removal step, in which sections of a solid sheet of material extending across a flat plane are removed to form a plurality of elongated holes extending transversely between longitudinally extending support sections of the solid sheet and transversely extending sections of the solid sheet extending between the longitudinally extending support sections;
a first bending step, in which the longitudinally extending support sections are bent such that they extend substantially perpendicularly from the transversely extending sections;
a second bending step, in which the transversely extending sections are bent such that a part of each of the transversely extending sections is rotated around the axis in which they extend transversely until it is substantially perpendicular to the flat plane over which the solid sheet originally extends.

10. The method for producing a ladder-like grating according to claim 9, wherein the method comprises, after the first bending step and before the second bending step,
a pressing step in which each of the transversely extending sections is pressed downward along one of its transversely extending edges to rotate it around the axis in which it extends transversely.

11. The method for producing a ladder-like grating according to claim 9, wherein the material removing step is a laser cutting process.

12. The method for producing a ladder-like grating according to claim 9, wherein the material removing step provides the transversely extending sections with anti-slip features.

13. The method for producing a ladder-like grating according to claim 12, wherein the anti-slip features comprise a plurality of depressions or projections along the transversely extending edges of the transversely extending sections.

14. The method for producing a ladder-like grating according to claim 9, wherein the rotation of the transversely extending sections in the second bending step is effectuated by contacting each transversely extending section on opposite sides by a clamping device and rotating the clamping device around the transversely extending section, wherein each transversely extending section is assigned a clamping device.

15. The method for producing a ladder-like grating according to claim 9, wherein, in the second bending step, the transversely extending sections are bent simultaneously.
